(19) United States
(12) Patent Application Publication
(10) Pub. No.: US 2025/0195315 A1
(43) Pub. Date: Jun. 19, 2025

(54) LOWER LEG MASSAGER

(71) Applicant: DAITO ELECTRIC MACHINE INDUSTRY COMPANY LIMITED, Higashi-Osaka-shi, Osaka (JP)

(72) Inventors: Tetsuya ISHIKAWA, Higashi-Osaka-shi (JP); Shinsaku SHIMIZU, Higashi-Osaka-shi (JP)

(73) Assignee: DAITO ELECTRIC MACHINE INDUSTRY COMPANY LIMITED, Higashi-Osaka-shi, Osaka (JP)

(21) Appl. No.: 18/842,584

(22) PCT Filed: Feb. 20, 2023
(86) PCT No.: PCT/JP2023/005928

§ 371 Date: Aug. 29, 2024

(30) Foreign Application Priority Data
Jun. 3, 2022 (JP) 2022-090947

(51) Int. Cl. A61H 9/00

(52) U.S. Cl. CPC A61H 9/0078; A61H 2201/0103; A61H 2201/5071; A61H 2205/106; A61H 2205/12

(57) ABSTRACT

A lower leg massager includes a mechanism to enable movement of a treatment member when massaging target areas of a lower leg, that allows the treatment element mounted to the treatment member to be firmly pressed against the target areas, and that achieves an effective massage. The lower leg massager includes a vertical massage mechanism to move vertically for performing a massage operation on a calf and shin, i.e. treatment target areas. The vertical massage mechanism includes an outer treatment member which covers and presses the lateral side of the shin; a rear treatment member, disposed inwardly of the outer treatment member so as to lie behind the calf, for pressing the back side of the calf; and a pressing mechanism to enable a pressing massage to the target areas by varying the position of one of the outer treatment member and the rear treatment member.

### TECHNICAL FIELD

The present invention relates to a lower leg massager suitable for massage to lower legs.

### BACKGROUND ART

Leg massagers capable of massaging a lower limb, and more particularly massaging lower leg areas ranging from a below-knee area to a foot through a calf, have been commercially available to date. For example, Patent Literature 1 discloses a lower leg massager comprising: a vertical massage mechanism that performs massage on treatment target areas ranging from a below-knee area to an ankle through a calf; a horizontal massage mechanism that performs massage on treatment target areas ranging from an ankle to a foot; and a massage mechanism for sole that performs massage on treatment target areas including a sole and arch of a foot.

### PRIOR ART REFERENCE

### Citation List

Patent Literature 1: Japanese Examined Patent Publication JP-B2

### SUMMARY OF INVENTION

### Technical Problem

The lower leg massager disclosed in Patent Literature 1 can be used to attain a high degree of massage effect.

However, user demands for lower leg massagers recently include a request asking a massager capable of providing professional massage-like kneading treatment, for example, massage treatment to remove swelling of a calf, or specifically calf massage to help speed recovery from fatigue by improving the flow of blood and lymph, and finger-pressure (i.e., acupressure)-like massage to a foot, a sole, etc. That is, there have been desires for a lower leg massager capable of performing massage on treatment target areas of a lower leg, including a calf, a foot, and a sole, with greater effect.

In order to achieve even greater massage effect, the inventors of the invention of the application concerned have earnestly carried out research and study on the shapes, arrangement, movement, etc. of massaging members that constitute a lower leg massager.

In view of the above challenges, it is an object of the present invention to provide a lower leg massager including a mechanism that enables movement of a treatment member for performing massage when applying massage to a treatment target area of a lower leg, in which a treatment element mounted to the treatment member can be firmly pressed against the treatment target area, thereby performing massage on the treatment target area with greater effect.

### Solution to Problem

To achieve the above object, the present invention adopts the following technical means.

The present invention provides a lower leg massager comprising a vertical massage mechanism to move in a vertical direction for performing massage operation on a calf and a shin which are treatment target areas. The vertical massage mechanism includes an outer treatment member, formed so as to cover a lateral side of the shin, for pressing the lateral side of the shin, a rear treatment member, disposed inwardly of the outer treatment member so as to lie behind the calf, for pressing a back side of the calf, and a pressing mechanism to enable pressing massage to the treatment target areas by varying a position of one of the outer treatment member and the rear treatment member.

In the invention, it is preferable that the pressing mechanism includes a first pressing mechanism, and that the first pressing mechanism enables pressing of the lateral side of the shin by varying a position of the outer treatment member in a right-left direction.

In the invention, it is preferable that the first pressing mechanism comprises a first air bag which is inflated and deflated repeatedly, and that the first air bag is inflated to move the outer treatment member inward, thereby applying pressing massage to the lateral side of the shin.

In the invention, it is preferable that the pressing mechanism includes a second pressing mechanism, and that the second pressing mechanism enables pressing of the back side of the calf by varying a position of the rear treatment member in a front-rear direction.

In the invention, it is preferable that the second pressing mechanism comprises a second air bag which is inflated and deflated repeatedly, and that the second air bag is inflated to move the rear treatment member frontward, thereby applying pressing massage to the back side of the calf.

In the invention, it is preferable that a horizontal massage mechanism is provided to perform massage operation on a foot, that the horizontal massage mechanism includes a sole treatment member in projection form, mounted so as to lie under the foot, for pressing a back side of the foot, that the pressing mechanism includes a third pressing mechanism, and that the third pressing mechanism enables pressing of the back side of the foot by lifting the sole treatment member upward.

In the invention, it is preferable that the third pressing mechanism comprises a third air bag which is inflated and deflated repeatedly, and that the third air bag is inflated to move the sole treatment member upward, thereby applying pressing massage to the back side of the foot.

In the invention, it is preferable that the horizontal massage mechanism includes a foot retention mechanism to prevent the foot from slipping off upwardly during upward movement of the vertical massage mechanism.

In the invention, it is preferable that the foot retention mechanism includes a fourth air bag which is inflated and deflated repeatedly, and that the fourth air bag is inflated to hold down the foot, thereby preventing the foot from slipping off upwardly during a time when the vertical massage mechanism is being moved upward by drive operation of an up-and-down movement mechanism.

In the invention, it is preferable that a controller is provided to control the vertical massage mechanism, and that the controller exercises drive control so as to effect supply of compressed air to the first air bag and supply of compressed air to the second air bag in a switchable manner.

In the invention, it is preferable that the controller is configured to exercise control in a manner such that the second air bag is inflated following completion of inflation of the first air bag.

In the invention, it is preferable that the controller is configured to exercise control in a manner permitting adjustment of an abutting contact position of the rear treatment member in the front-rear direction by inflating the second air bag prior to inflating the first air bag.

In the invention, it is preferable that a pressure detector is provided to detect a pressure of at least one of the first air bag and the second air bag, and that the controller is configured to recognize the pressure of the first air bag and/or the pressure of the second air bag detected by the pressure detector, and then adjust the pressure of each of the first air bag and the second air bag.

In the invention, it is preferable that the vertical massage mechanism includes an inner treatment member, positioned face to face with the outer treatment member, for pressing a medial side of the calf, and that the inner treatment member is configured to apply pressing massage to the medial side of the calf while being moved toward the outer treatment member by the pressing mechanism.

### Advantageous Effects of Invention

The present invention provides a lower leg massager including a mechanism that enables movement of a treatment member for performing massage when applying massage to a treatment target area of a lower leg, in which a treatment element mounted to the treatment member can be firmly pressed against the treatment target area, thereby performing massage on the treatment target area with greater effect.

### BRIEF DESCRIPTION OF DRAWINGS

FIG. 1 is a general view in schematic form showing a lower leg massager embodying the present invention.

FIG. 2 is a perspective view of the lower leg massager embodying the present invention as seen from the front.

FIG. 3 is a perspective view of the lower leg massager embodying the present invention as seen from the rear.

FIG. 4 is a plan view of the lower leg massager embodying the present invention.

FIG. 5 is an enlarged view of an outer treatment element, an outer treatment member, and a right-hand first air bag.

FIG. 6 is an enlarged view of a vertical massage mechanism.

FIG. 7 is an enlarged view of a rear treatment member and a second air bag.

FIG. 8 is an enlarged view of projections for sole and a third air bag.

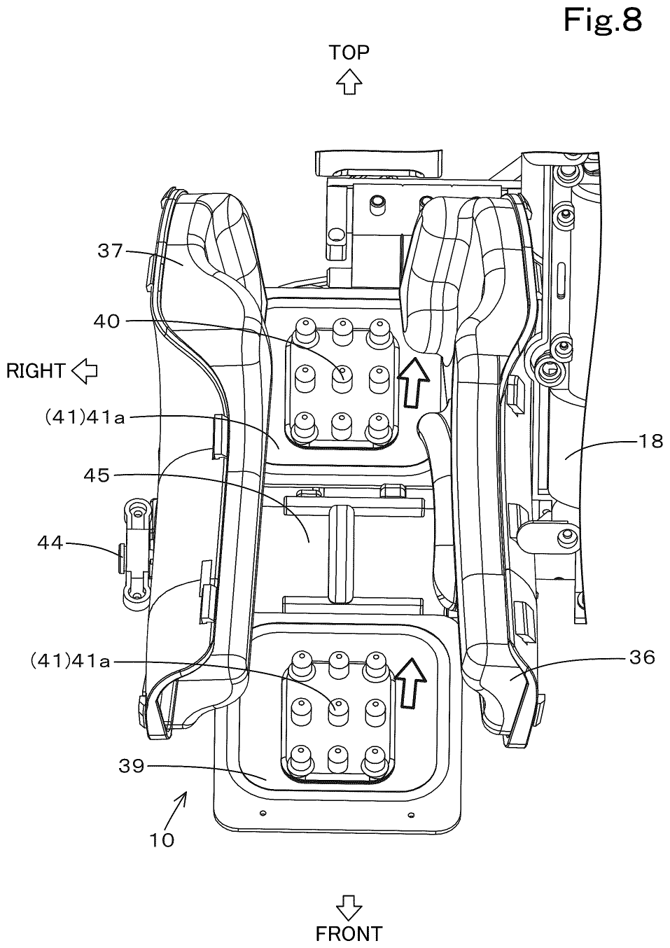

### DESCRIPTION OF EMBODIMENTS

A lower leg massager 1 according to an embodiment of the present invention will now be described with reference to the drawings.

The following embodiment is given by way of example of carrying the present invention into practice, and hence is not intended to be limiting of the structural features of the present invention. In the drawings, some constituent components are not shown or are indicated by imaginary lines or the like for clarity of illustration.

The directions with respect to the lower leg massager 1 embodying the present invention, including a front-rear direction and a right-left direction, are as shown in the drawings. These directions coincide with those as viewed from a user sitting in a chair or the like with a lower leg L placed in the lower leg massager 1. The directions indicated in the drawings are used as the reference to describe the lower leg massager 1 embodying the present invention.

In this description, mainly the rear (i.e., back) side of that part of human lower leg L extending from the below-knee area to the above-malleolus K (i.e., ankle K) area is referred to as a “calf C”. Moreover, mainly the front (i.e., surface) side of that part of the lower leg L extending from the below-knee area to the above-malleolus K (i.e., ankle K) area is referred to as a “shin S”. In addition, the ankle K-to-toe area of the lower leg L is referred to as a “foot F”. Other areas of the lower leg L will be described on an as-needed basis.

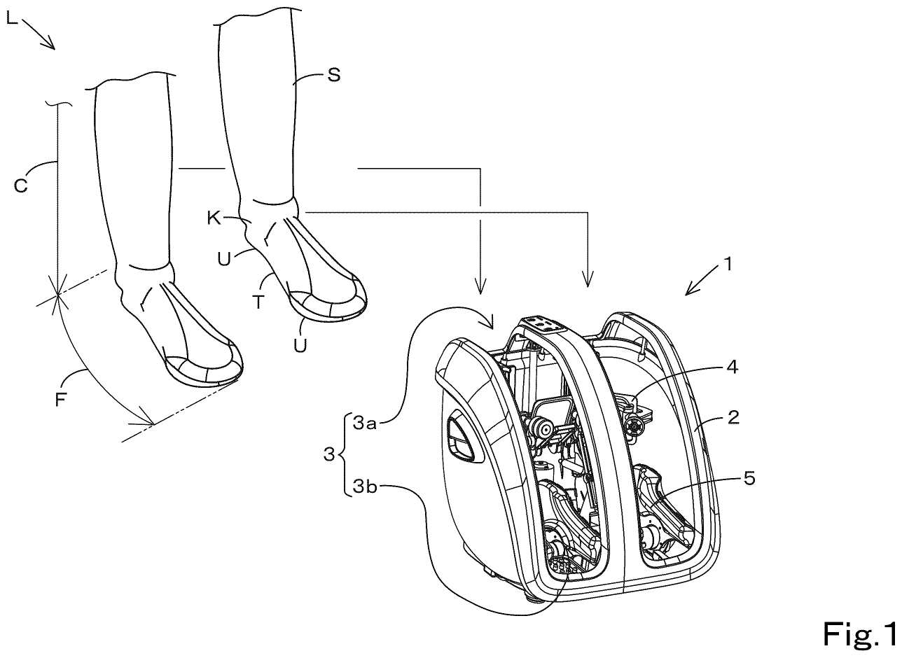

As shown in FIG. 1, the lower leg massager 1 according to this embodiment comprises a case body 2 which is substantially square-shaped as viewed from the front, and is boot-shaped as viewed from the side.

The case body 2 has a front face formed with a pair of left-hand and right-hand recessed parts for massage treatment 3, being simply called treatment recessed parts 3, into each of which the lower leg L can be inserted. That is, the treatment recessed parts 3 are spaced apart in the right-left direction. The left-hand treatment recessed part 3 receives the left lower leg L, and the right-hand treatment recessed part 3 receives the right lower leg L.

The treatment recessed part 3 comprises: an upper treatment recess 3a, constituting an approximately upper half portion of it, having an open front and an open top; and a lower treatment recess 3b, constituting an approximately lower half portion of it, having an open top and an open front. The upper treatment recess 3a and the lower treatment recess 3b communicate with each other in a vertical direction. While the upper treatment recess 3a receives the calf C, the lower treatment recess 3b receives the foot F.

Within the upper treatment recess 3a and the lower treatment recess 3b, there is provided a cushion member (not shown) made of, for example, a sponge material or an urethane material. In addition, at the opening (i.e., the surface) of the upper treatment recess 3a and the lower treatment recess 3b, there is provided a lining (not shown) made of a stretchable material having adequate air permeability, such as a cloth material or a leather material.

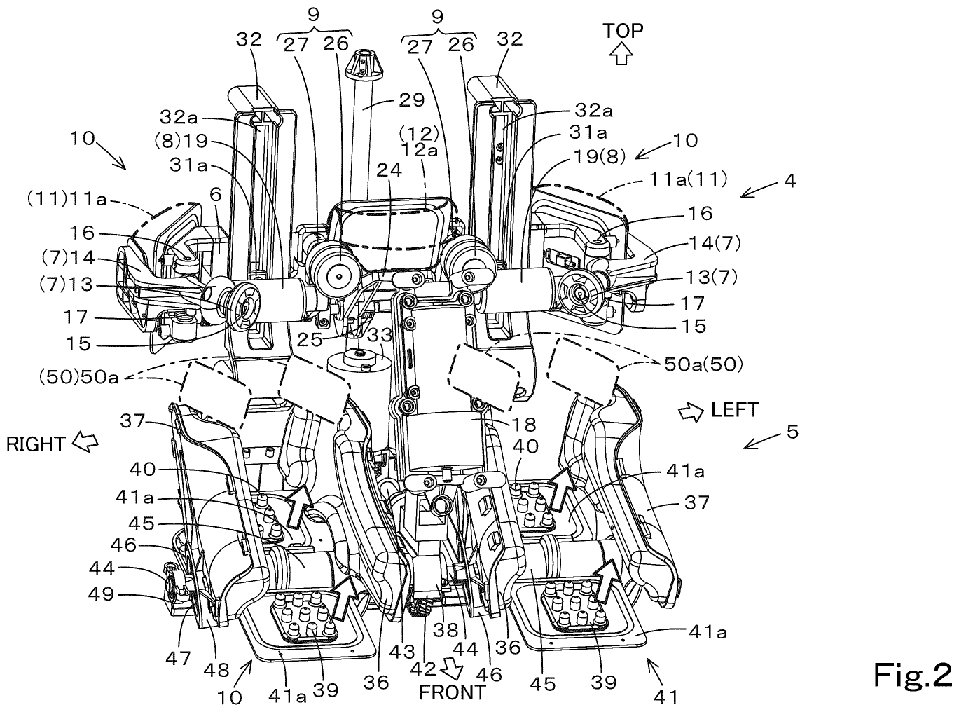

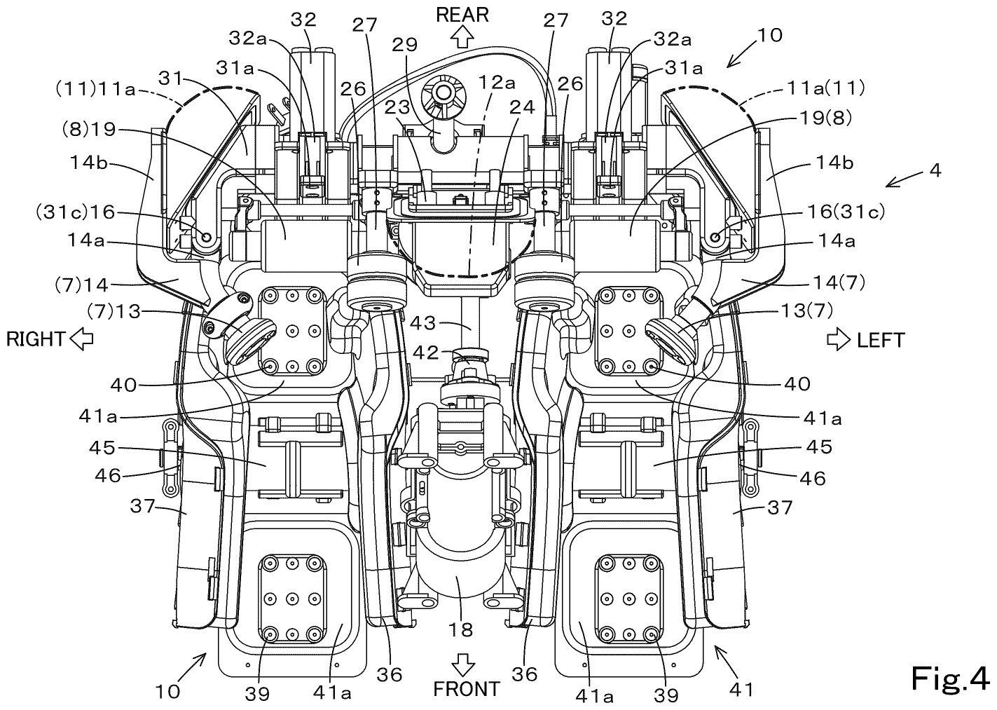

As shown in the drawings such as FIGS. 2 to 4, the lower leg massager 1 embodying the present invention comprises: a vertical massage mechanism 4 that enables pressing massage to each of the left and right calves C by pressing the rear (i.e., back) side of each calf C, and also enables pressing massage to each of the left and right shins S by pressing the lateral side of each shin S; a horizontal massage mechanism 5 that enables kneading massage to each of the left and right feet F by kneading the opposite sides of each foot F in the right-left direction, and also enables pressing massage to a sole U by pressing the sole U from below; and an up-and-down movement mechanism 6 that moves the vertical massage mechanism 4 in the vertical direction.

The vertical massage mechanism 4, which is disposed within the left-hand and right-hand upper treatment recesses 3a, applies massage to a treatment target area, or specifically the lateral side of the shin S, by operating an outer treatment member 7 with a first pressing mechanism 11, or specifically a first air bag 11a, which will hereafter be described, and also applies massage to a treatment target area, or specifically the back side of the calf C, by operating a rear treatment member 8 with a second pressing mechanism 12, or specifically a second air bag 12a.

The horizontal massage mechanism 5, which is disposed within the left-hand and right-hand lower treatment recesses 3b, applies kneading massage to a treatment target area, or specifically the foot F, by causing horizontal massaging members 36 and 37 (described later) to rock in the right-left direction, applies massage to a treatment target area, or specifically the front area and the rear area of the sole U, by forcing projections for sole 39 and 40 upwardly with a third pressing mechanism 41, or specifically a third air bag 41a (described later), and applies massage to a treatment target area, or specifically plantar arch T, by using a sole-massaging roller 45.

The up-and-down movement mechanism 6 moves the vertical massage mechanism 4 in the vertical direction to allow the vertical massage mechanism 4 to massage the lateral side of the shin S and the back side of the calf C throughout their length in the vertical direction.

The vertical massage mechanism 4 will be detailed first.

The vertical massage mechanism 4 in this embodiment comprises: the (at least one) outer treatment member 7, or specifically a first roller 13, formed so as to cover the lateral side of the shin S, for pressing the lateral side of the shin S; the (at least one) rear treatment member 8, or specifically a second roller 19, disposed inwardly of the outer treatment member 7 so as to lie behind the calf C, for pressing the back side of the calf C; and an (or at least one) inner treatment member 9, or specifically a third roller 26, positioned face to face with the outer treatment member 7, for pressing the medial side of the calf C.

The vertical massage mechanism 4 in this embodiment further includes a (or at least one) pressing mechanism 10 that enables pressing massage to treatment target areas, such as the shin S and the calf C, by varying the position of one of the outer treatment member 7, the rear treatment member 8, and the inner treatment member 9.

The pressing mechanism 10 comprises: the first pressing mechanism 11 that presses the outer treatment member 7 more firmly against the lateral side of the shin S; and the second pressing mechanism 12 that presses the rear treatment member 8 more firmly against the rear side (i.e., back side) of the calf C.

As shown in the drawings such as FIGS. 2 to 6, the outer treatment member 7 is configured to apply pressing massage to the tibialis anterior muscle lying externally of the shinbone of the shin S, the peroneus longus muscle, which is the muscle extending over the lateral side of the shin S from the rearward calf C, etc.

The outer treatment member 7 comprises: an outer treatment element 13 (i.e., the first roller 13) that applies pressing and kneading massage to the lateral side of the shin S; and an arm member 14 that supports, at its tip, the first roller 13 for free rotation.

The arm member 14 has a front portion, which extends from a lengthwise intermediate point to a front end (i.e., the tip) thereof, bent inward in the right-left direction. The front portion of the arm member 14 is provided with a support shaft 15 protruding frontward. At least one first roller 13 is rotatably mounted on the support shaft 15. In this embodiment, the first roller 13 made in a disk-shaped roller form is paired, and the pair of first rollers 13 are provided on the support shaft 15 to be spaced from each other.

The first roller 13 is directed obliquely frontward and located outwardly in the right-left direction, when viewed in top plan, for making abutting contact with the tibialis anterior muscle, the peroneus longus muscle, etc. while keeping away from the shinbone of the shin S. This arrangement allows the first roller 13 to apply acupressure-like pressing massage to the lateral side of the shin S, such as the tibialis anterior muscle and the peroneus longus muscle.

An elastic material, such as a soft or hard resin or rubber material, may be used as the material of construction of the first roller 13.

The arm member 14 has a rear portion, which extends from the lengthwise intermediate point to a rear end thereof, bifurcated into two portions. The point of bifurcation corresponds to the base end portion of the arm member 14. At this base end portion, the arm member 14 is bifurcated to provide a leftward (i.e., inward) plate piece 14a and a rightward (i.e., outward) plate piece 14b. The inward plate piece 14a is provided at the base end portion with a hole part formed therethrough in the vertical direction. The hole part receives therein a rock shaft 16.

The rock shaft 16 is inserted into a hole part 31c formed in a vertical travel slider 31, which will hereafter be detailed, constituting the up-and-down movement mechanism 6. That is, the arm member 14 is coupled to the vertical travel slider 31 for free rotational movement in the right-left direction.

The inward plate piece 14a is also provided at the lower side with a coil spring 17 mounted so as to extend around the outer periphery of the rock shaft 16. The coil spring 17 moves the outer treatment member 7 outward in the right-left direction, and retains the outer treatment member 7 in an open position away from the rear treatment member 8. That is, the placement of the coil spring 17 allows a sufficiently large space to be left between the outer treatment member 7 (i.e., the first roller 13) and the rear treatment member 8 (i.e., the second roller 19) for insertion of the calf C and the shin S.

The coil spring 17 comprises: a coil main body formed of a wound wire material; and leg parts protruding radially outwardly from the coil main body. The coil main body is wound around the outer periphery of the rock shaft 16. Each of the leg parts protrudes from each of the upper and lower ends of the coil main body. The upper leg part is engaged to the base end portion of the arm member 14, and the lower leg part is engaged to the vertical travel slider 31. This engagement allows the outer treatment member 7 to be retained in the open position away from the rear treatment member 8. This mutually separated state is defined as a normal position.

The plate piece 14b, outwardly branching off from the arm member 14 at the base end thereof, is constructed of a flat platelike material having a predetermined breadth, and mounted in a vertically standing position. On inflation of the first air bag 11a of the first pressing mechanism 11, the plate piece 14b is forced outwardly in the right-left direction by the first air bag 11a.

On deflation of the first air bag 11a, the plate piece 14b is moved inward in the right-left direction through a reaction force exerted by the coil spring 17, and brought into contact with an outer wall surface 31b of the vertical travel slider 31, with the first air bag 11a lying between them.

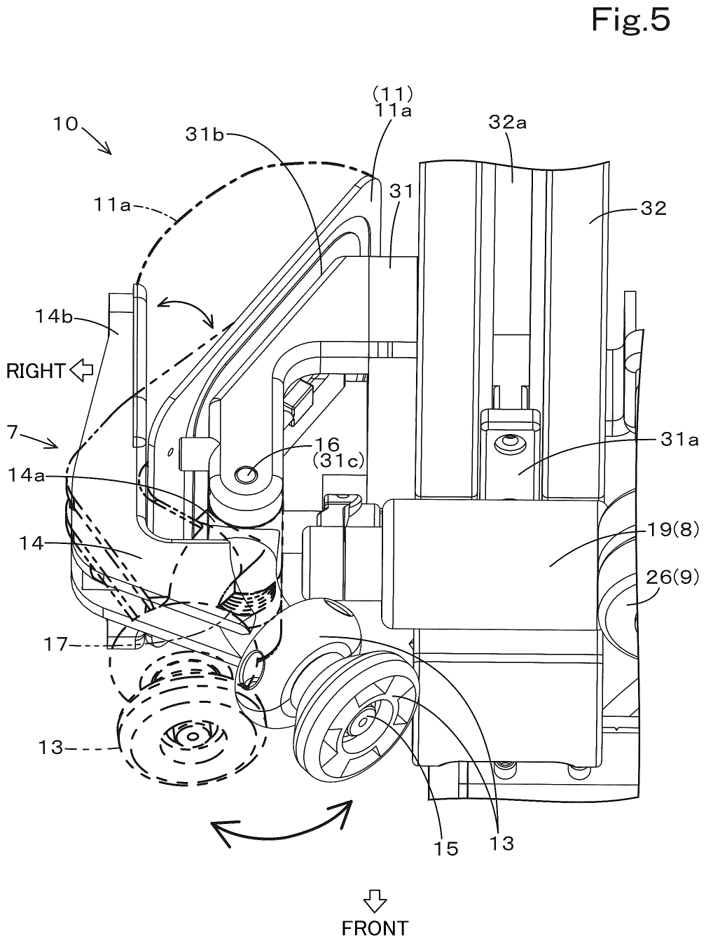

As indicated by the dash-double dot lines in FIG. 5, the movement of the plate piece 14b allows the arm member 14 to freely rock about the rock shaft 16 in the right-left direction. That is, the arm member 14 rocks at the base end portion about the rock shaft 16 in seesaw fashion.

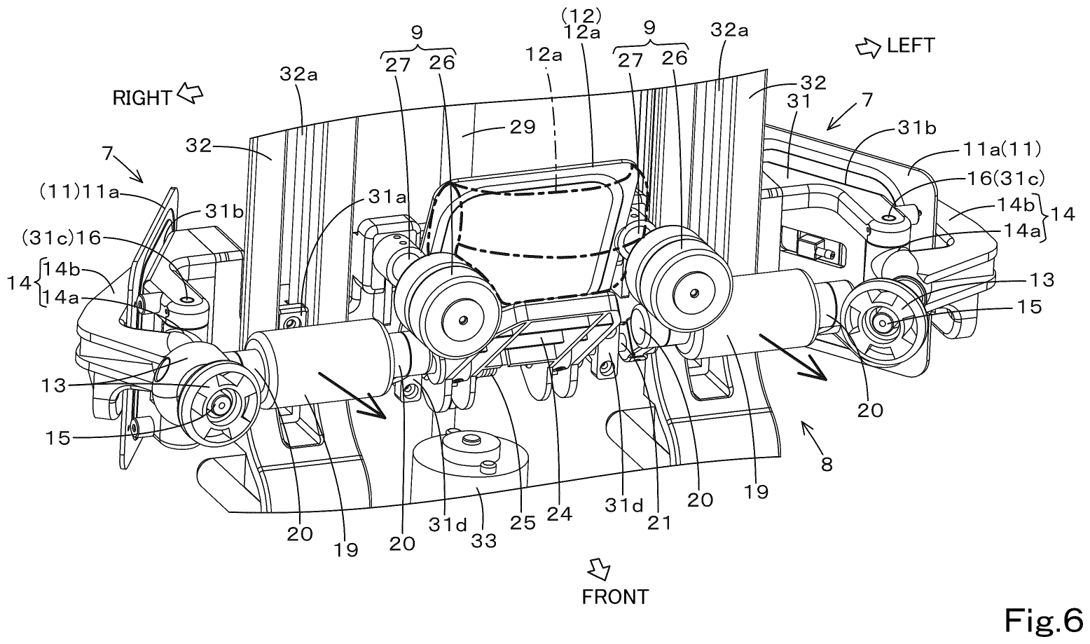

As shown in the drawings such as FIGS. 5 and 6, the first pressing mechanism 11 allows the first roller 13 to press itself against the lateral side of the shin S by varying the position of the outer treatment member 7 in the right-left direction. In other words, the first pressing mechanism 11 may serve as a pressing force-enhancing mechanism that provides greater pressing force by increasing the proximity of the roller to the lateral side of the shin C.

The first pressing mechanism 11 in this embodiment comprises: the first air bag 11a which is inflated and deflated repeatedly; and the coil spring 17 that produces a force to urge the arm member 14 back to an outward position.

The first air bag 11a is mounted to the outer wall surface 31b of the vertical travel slider 31 (detailed later) constituting the up-and-down movement mechanism 6. The outer wall surface 31b is directed obliquely outwardly in the rear direction.

As indicated by the alternate long and short dashed lines in the drawings such as FIGS. 2 to 5, the first air bag 11a is inflated obliquely outwardly in the rear direction.

The first air bag 11a is inflated with compressed air supplied from an air pump 18 which is situated centrally of the interior of the case body 2, is situated forward of the vertical massage mechanism 4, and is situated above the horizontal massage mechanism 5. The air pump 18 also exhausts the air from the first air bag 11a for deflation.

As the first air bag 11a is inflated obliquely outwardly in the rear direction with compressed air supplied from the air pump 18, the outer treatment member 7 moves toward the inner treatment member 9. To be specific, in the inflated state, the first air bag 11a forces the plate piece 14b, or specifically a lift arm 14b, of the arm member 14 outwardly in the right-left direction. The arm member 14 then rocks about the rock shaft 16 in the right-left direction, and the plate piece 14a moves inward in the right-left direction. The first roller 13 is brought nearer to the second roller 19.

That is, on actuation of the first air bag 11a (i.e., the pressing force-enhancing mechanism), the outer treatment member 7 attains a holding position close to the rear treatment member 8. At the holding position, the outer treatment member 7, in conjunction with the rear treatment member 8, squeezes the lateral side of the shin S, and the first roller 13 presses itself with greater force against the lateral side of the shin S accordingly.

That is, on inflation of the first air bag 11a, the first roller 13 of the outer treatment member 7 falls inward. At this position, the first roller 13 restrains the lateral side of the shin S ready to perform pressing massage.

The coil spring 17 urges the arm member 14 back to the outward position, and keeps the outer treatment member 7 and the rear treatment member 8 separated. As the first air bag 11a is deflated by exhausting the air from it with the air pump 18, the outer treatment member 7 moves away from the inner treatment member 9. To be specific, on deflation of the first air bag 11a, the plate piece 14b of the arm member 14 moves inward in the right-left direction through a reaction force exerted by the coil spring 17. The arm member 14 then rocks about the rock shaft 16 in the right-left direction, and the plate piece 14a moves outward in the right-left direction. The first roller 13 moves away from the second roller 19.

That is, on deflation of the first air bag 11a, the first roller 13 of the outer treatment member 7 returns to an outward position in the right-left direction, and is held in the normal position. At this position, the first roller 13 releases the shin S.

As shown in the drawings such as FIGS. 5 to 7, the rear treatment member 8 is positioned so that it can face the outer treatment member 7, with the calf C sandwiched between them, for applying pressing massage to the calf C such as the gastrocnemius muscle and the soleus muscle.

The rear treatment member 8 comprises: a rear treatment element 19 (i.e., the second roller 19) that applies pressing massage to the calf C from the rear; a guide arm member 20 that supports the second roller 19 for free rotation; and a support shaft 21 that supports the guide arm member 20 for free rotation.

The second roller 19 is a cylindrically shaped member having a central hole formed therethrough in the direction of its axis. The through hole receives therein a pivot shaft 22. That is, the second roller 19 is free to rotate about the pivot shaft 22. The second roller 19 extends with the pivot shaft 22 oriented horizontally in the right-left direction.

The second roller 19 has a widened face, or specifically a widened outer periphery, which makes contact with the calf C, for pressing itself against the calf C from the rear. An elastic material, such as a soft or hard resin or rubber material, may be used as the material of construction of the second roller 19.

The guide arm member 20 is a structural component elongated in the front-rear direction. A pair of guide arm members 20 are arranged on the right and left sides, with the second roller 19 lying between them. The guide arm members 20 each support the corresponding one of the opposite ends of the pivot shaft 22 that pivotally supports the second roller 19 for free rotation.

The front end of the guide arm member 20 is formed with a hole part in which the pivot shaft 22 fits. The base end of the guide arm member 20 has a hole formed therethrough for insertion of the support shaft 21. The guide arm member 20 rotates together with the support shaft 21. As the support shaft 21 rotates in the forward direction, the guide arm member 20 rotates in the forward direction correspondingly.

In the lower portion of the vertical massage mechanism 4, the support shaft 21 is installed so as to extend horizontally in the right-left direction in spanning fashion. The support shaft 21, constructed of an elongated shaft, supports a pair of the rear treatment members 8 (i.e., a pair of the second rollers 19) that are spaced from each other in the right-left direction by a distance approximately equal to the width of each of the right and left lower legs L (i.e., the width of the calf C). The support shaft 21 also supports the second pressing mechanism 12 at the lengthwise midportion thereof between the paired rear treatment members 8. The support shaft 21 is supported on a support member 31d disposed at the front side of the vertical travel slider 31 (detailed later) constituting the up-and-down movement mechanism 6.

That is, in each of the rear treatment members 8, the second roller 19 is rotatably supported by the paired left-hand and right-hand guide arm members 20, and, the guide arm members 20 are supported by the support shaft 21 rotatably about the axis of the support shaft 21. This arrangement allows the second roller 19 to move in the front-rear direction.

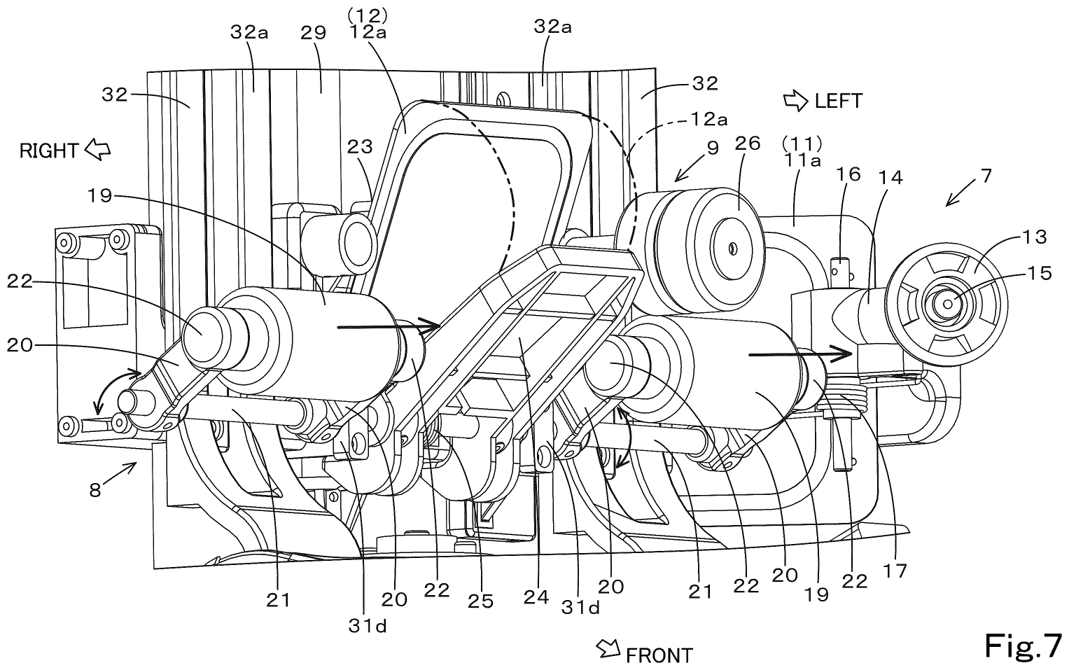

As shown in FIG. 7, the second pressing mechanism 12 allows the second rollers 19 to press themselves against the back sides of the calves C by varying the position of the rear treatment members 8 in the front-rear direction. In other words, the second pressing mechanism 12 may serve as a pressing force-enhancing mechanism that provides greater pressing force by increasing the proximity of the rollers to the rear sides (i.e., the back sides) of the calves C.

The second pressing mechanism 12 in this embodiment comprises: the second air bag 12a which is inflated and deflated repeatedly; an air bag holder 23 that securely holds the second air bag 12a; a lift arm member 24, or specifically a pusher 24, which moves frontward on inflation of the second air bag 12a; and a coil spring 25 that produces a force to urge the lift arm member 24 back to a rearward position.

The second air bag 12a is mounted to the air bag holder 23. The second air bag 12a is inflated with compressed air supplied from the air pump 18 situated centrally of the interior of the case body 2. The air pump 18 also exhausts the air from the second air bag 12a for deflation.

As the second air bag 12a is inflated frontwardly with compressed air supplied from the air pump 18, the rear treatment members 8 move toward the front. To be specific, in the inflated state, the second air bag 12a forces the lift arm member 24 frontwardly. The lift arm member 24 then rocks about the support shaft 21 in the forward direction. The support shaft 21 rotates with accompanying rotation of the guide arm members 20, thus causing the second rollers 19 to move frontward. Each of the second rollers 19 is brought nearer to each of the first rollers 13. That is, each rear treatment member 8 is moved frontward to apply pressing massage to the back side of the corresponding calf C.

The air bag holder 23, constructed of a flat plate-shaped material, is disposed at the midportion of the front side of the vertical travel slider 31 (detailed later) constituting the up-and-down movement mechanism 6. The second air bag 12a is mounted to the front side of the air bag holder 23.

As indicated by the alternate long and short dashed lines in the drawings such as FIGS. 2, 4, 6, and 7, the second air bag 12a is inflated frontwardly.

The lift arm member 24, or specifically an air lift arm 24, constructed of a flat plate-shaped material, is mounted with its front end side facing upward. The base end of the lift arm member 24 is formed with a through hole which has a horizontally oriented axis, and points in the right-left direction. The through hole receives therein the support shaft 21. The lift arm member 24 rotates together with the support shaft 21. As the support shaft 21 rotates in the forward direction, the lift arm member 24 rotates in the forward direction correspondingly. That is, the lift arm member 24 rocks about the support shaft 21 in the front-rear direction.

The coil spring 25 is disposed at the base end of the lift arm member 24. The coil spring 25 comprises: a coil main body formed of a wound wire material; and leg parts protruding radially outwardly from the coil main body. The coil main body is wound around the outer periphery of the support shaft 21. Each of the leg parts protrudes from each of the left end and the right end of the coil main body. The leftward leg part is engaged to the base end portion of the lift arm member 24. The rightward leg part is engaged to the vertical travel slider 31. This engagement allows the lift arm member 24 to be retained in a closed position near the air bag holder 23 (i.e., the second air bag 12a). This mutually separated state is defined as a normal position.

That is, on actuation of the second air bag 12a (i.e., the pressing force-enhancing mechanism), the rear treatment members 8 reach a holding position close to the respective outer treatment members 7. In the holding position, the rear treatment members 8, in conjunction with the outer treatment members 7, squeeze the back sides of the calves C, and the second rollers 19 press themselves with greater forces against the respective back sides of the calves C accordingly.

That is, on inflation of the second air bag 12a, the second rollers 19 of the rear treatment members 8 are lowered frontward. At this position, the second rollers 19 restrain the back sides of the calves C ready to perform pressing massage.

The coil spring 25 urges the lift arm member 24 back to the rearward position, and keeps the lift arm member 24 and the air bag holder 23 close to each other. As the second air bag 12a is deflated by exhausting the air from it with the air pump 18, the second rollers 19 of the rear treatment members 8 are urged back to the rearward position through the force exerted by the coil spring 25.

To be specific, on deflation of the second air bag 12a, the coil spring 25 exerts a reaction force to urge the lift arm member 24 to move rearwardly about the support shaft 21. The lift arm member 24 is brought nearer to the air bag holder 23. The second rollers 19 move away from the first rollers 13, respectively.

That is, on deflation of the second air bag 12a, the reaction force exerted by the coil spring 25 urges the second rollers 19 of the rear treatment members 8 rearwardly back to the normal position. At this position, the second rollers 19 release the calves C.

The first rollers 13 of the outer treatment members 7 and the second rollers 19 of the rear treatment members 8 unitarily move up and down concurrently with the up-and down movement of the vertical travel slider 31 of the up-and-down movement mechanism 6. With inflation and deflation of each of the first air bags 11a, each of the first rollers 13 repeatedly applies acupressure-like effective pressing massage to the lateral side of the corresponding shin S such as the tibialis anterior muscle and the peroneus longus muscle. In addition, with inflation and deflation of the second air bag 12a, each of the second rollers 19 repeatedly applies acupressure-like effective pressing massage to the back side of the corresponding calf C such as the gastrocnemius muscle and the soleus muscle.

Each of the inner treatment members 9 is positioned so that it can face the corresponding outer treatment member 7, with the corresponding calf C sandwiched between them, for applying pressing and kneading massage to the medial side of the calf C.

Each of the inner treatment members 9 comprises: an inner treatment element 26 (i.e., the third roller 26) that applies pressing and kneading massage to the medial side of the corresponding calf C; and an arm member 27 that supports, at its front end, the third roller 26 for free rotation.

The arm members 27, constructed of cylindrically-shaped rods, are disposed at the midportions of the front side of the vertical travel slider 31. The arm members 27 are mounted so as to protrude frontward, and are adjacent to the air bag holder 23.

At least one third roller 26 is rotatably mounted to the front side of each arm member 27. In this embodiment, the third roller 26 made in a disk-shaped roller form is paired, and the pair of third rollers 26 are provided on each arm member 27.

Each of the third rollers 26 is located inwardly in the right-left direction, or specifically located centrally of the case body 2, for making abutting contact with the medial side of the corresponding calf C. This arrangement allows the third roller 26 to apply acupressure-like pressing massage to the corresponding calf C, such as the gastrocnemius muscle at the medial side of the corresponding calf C.

An elastic material, such as a soft or hard resin or rubber material, may be used as the material of construction of the third roller 26.

When viewed from the front, the arrangement of the treatment elements comprises, in top-to-bottom order, the third rollers 26, the first rollers 13, and the second rollers 19. When viewed in top plan, the arrangement of the treatment elements comprises, in front-to-rear order, the first rollers 13, the third rollers 26, and the second rollers 19.

As described above, the third rollers 26 are secured to the vertical travel slider 31. Thus, the up-and-down movement mechanism 6 allows the third rollers 26 to move in synchronism with the vertical movement of the first and second rollers 13 and 19 in a manner such that the first to third rollers move at the same speed and in the same direction.

That is, there are provided the first roller 13 (i.e., the outer treatment member 7), the first air bag 11a (i.e., the first pressing mechanism 11), the second roller 19 (i.e., the rear treatment member 8), the second air bag 12a (i.e., the second pressing mechanism 12), the third roller 26 (i.e., the inner treatment member 9), etc. This arrangement provides greater holding pressure to hold the lateral side of the shin S, the back and medial sides of the calf C, etc., and also allows massage to be performed on many more areas with increased number of pressing parts. Thus, even greater massage effect can be achieved by repeating acupressure-like effective pressing massage to the lateral side of the shin S such as the tibialis anterior muscle and the peroneus longus muscle, as well as to the back side of the calf C such as the gastrocnemius muscle and the soleus muscle.

The vertical massage mechanism 4 in this embodiment further includes the up-and-down movement mechanism 6 that moves the outer treatment members 7 with the first rollers 13, the rear treatment members 8 with the second rollers 19, the inner treatment members 9 with the third rollers 26, etc.

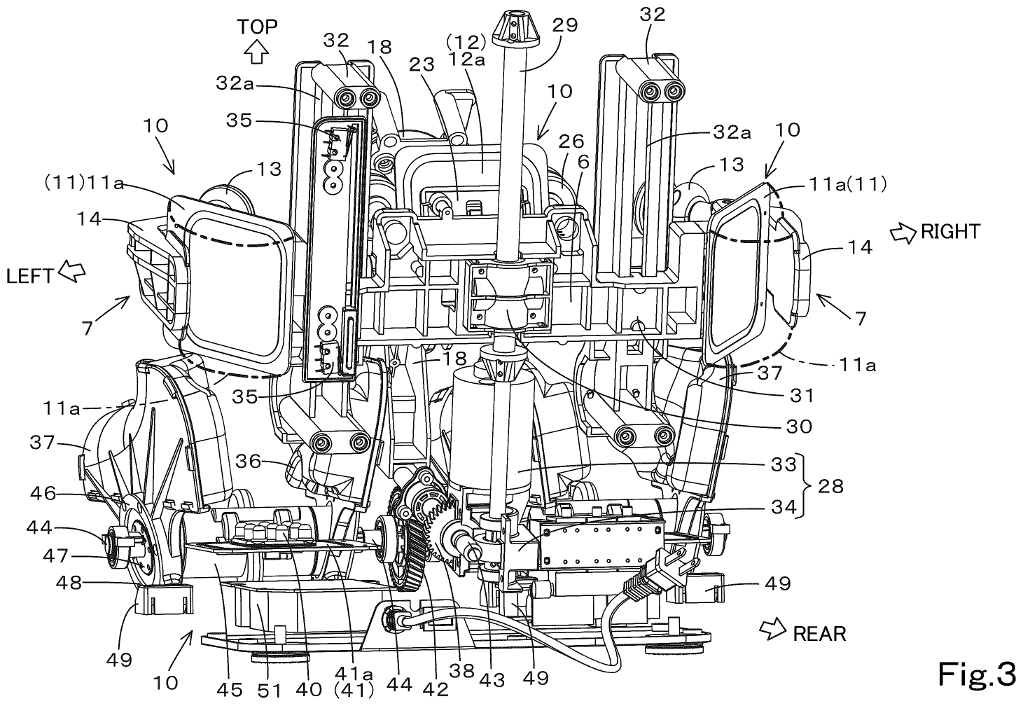

As shown in the drawings such as FIGS. 2 and 3, the up-and-down movement mechanism 6 comprises: a driver 28 for producing a driving force; a screw shaft 29 which is rotated by the driving force; a slider piece 30 which travels on the screw shaft 29; the vertical travel slider 31 which is moved in the vertical direction by the slider piece 30; and a pair of right-hand and left-hand vertical rails 32.

The driver 28 comprises: a drive motor 33 that produces a driving force; and a gear case 34 that effects speed reduction to a predetermined level. The drive motor 33 is situated forward of the screw shaft 29, and disposed toward the bottom of the case body 2.

The gear case 34 is situated below the drive motor 33, and disposed toward the bottom of the case body 2. The gear case 34 receives therein the output shaft of the drive motor 33 and the lower end of the screw shaft 29. Within the gear case 34, a plurality of gears are housed to effect speed reduction to a predetermined level.

The screw shaft 29, constructed of an elongated shaft member, is mounted with its axis directed in the vertical direction. The slider piece 30 vertically travels on the screw shaft 29. The slider piece 30 is mounted to the midportion of the vertical travel slider 31.

The vertical travel slider 31, constructed of a horizontally elongated member, travels in the vertical direction concurrently with the up-and-down movement of the slider piece 30. At the midportion of the front side of the vertical travel slider 31, there is disposed the air bag holder 23 provided at the front side with the second air bag 12a.

The vertical travel slider 31 has frontwardly protruding opposite end portions. The front end of each protruding end portion is formed with the hole part 31c. The hole part 31c receives therein the rock shaft 16 that enables horizontal rocking motion of the arm member 14.

The paired vertical rails 32 are arranged on the right and left sides, with the screw shaft 29 lying between them. Each of the vertical rails 32 is mounted to the front face of the rear wall of the case body 2, and is provided at the front side with a vertically elongated rail groove 32a. A slider part 31a mounted to the vertical travel slider 31 runs along the long rail groove 32a.

The opposite end portions of the vertical travel slider 31 are each provided with the outer treatment member 7 including the at least one first roller 13, and the first pressing mechanism 11 including the first air bag 11a. That is, there are provided a pair of right and left outer treatment members 7, and a pair of right and left first pressing mechanisms 11.

The opposite end portions of the vertical travel slider 31 are each provided with the outer wall surface 31b directed obliquely outwardly in the rear direction. The first air bag 11a is mounted to the outer wall surface 31b. In addition, the opposite end portions of the vertical travel slider 31 are each formed with the hole part 31c into which the rock shaft 16 is inserted. At the central lower portion of the front side of the vertical travel slider 31, the support member 31d is provided to support the support shaft 21.

The left-hand vertical rail 32 is provided at the rear side thereof with a position detector 35 to detect the vertical position of the vertical massage mechanism 4 which is moved up and down by the up-and-down movement mechanism 6. A limit switch is used for the position detector 35 in this embodiment.

The lower leg massager 1 according to this embodiment includes the horizontal massage mechanism 5 configured to perform massage operation on the below-ankle K areas, i.e., the foot or feet F. The horizontal massage mechanism 5 will now be described.

The horizontal massage mechanism 5 comprises: (at least one pair of) the horizontal massaging members 36 and 37 that apply kneading massage to the foot F of (at least) one leg; and a drive mechanism for kneading massage 38, being simply called a kneading drive mechanism 38, for producing a driving force to allow the horizontal massaging members 36 and 37 to perform kneading massage operation on the foot F.

As shown in the drawings such as FIGS. 2 to 7, the horizontal massage mechanism 5 in this embodiment further comprises (at least one pair of) sole treatment members 39 and 40 in projection form (i.e., the projections for sole 39 and 40), mounted so as to lie just under the foot F, for pressing the back side U of the foot F.

In a location forward of the sole-massaging roller 45 which will hereafter be described, or specifically a location corresponding to a front portion of the sole U forward of the plantar arch T (i.e., the toe-side area of the sole U), the sole treatment member 39 (i.e., the projection for sole 39) is placed to massage the front side of the sole U. The projection for sole 39 is interposed between the horizontal massaging members 36 and 37. The projection for sole 39 is placed on a foot support member (not shown) for supporting the front portion of the sole U (i.e., the back of the toe) of the foot F. The projection for sole 39 includes a plurality of projection elements to apply pressing massage to the front portion of the sole U.

In addition, in a location rearward of the sole-massaging roller 45 (described later), or specifically a location corresponding to a rear portion of the sole U rearward of the plantar arch T (i.e., the heel-side area of the sole U), the sole-massaging member 40 (i.e., the projection for sole 40) is placed to massage the rear portion of the sole U. The projection for sole 40 is interposed between the horizontal massaging members 36 and 37. The projection for sole 40 is placed on a foot support member (not shown) for supporting the rear portion of the sole U (i.e., the bottom of the heel) of the foot F. The projection for sole 40 includes a plurality of projection elements to apply pressing massage to the rear portion of the sole U.

The arrangement, the protruding height, the materials of construction, the number, etc. of the projections for sole 39 and 40 may be suitably selected with consideration given to acupressure points on the sole.

The pressing mechanism 10 includes the (at least one) third pressing mechanism 41 that allows the projections for sole 39 and 40 to press themselves with greater force against the sole U. The third pressing mechanism 41 lifts the projections for sole 39 and 40 up to allow them to press themselves against the sole U of the foot F. In other words, the third pressing mechanism 41 may serve as a pressing force-enhancing mechanism that provides greater pressing force by increasing the proximity of the projections for sole 39 and 40 to the sole U of the corresponding foot F.

The third pressing mechanism 41 in this embodiment includes the third air bags 41a which are inflated and deflated repeatedly.

One third air bag 41a is situated above the foot support member (not shown) for supporting the front side (i.e., the toe-side area) of the sole U of the foot F, and situated below the projection for sole 39. That is, the third air bag 41a is interposed between the foot support member and the projection for sole 39.

Also, the other third air bag 41a is disposed above the foot support member (not shown) for supporting the rear portion (i.e., the heel-side area) of the sole U of the foot F, and situated below the projection for sole 40. That is, the third air bag 41a is interposed between the foot support member and the projection for sole 40.

Each of the third air bags 41a is inflated upwardly with compressed air supplied from the air pump 18 situated centrally of the interior of the case body 2. On de-actuation of the air pump 18, the weight of the foot F in itself exhausts the air from each of the third air bags 41a for deflation.

As the front third air bag 41a is inflated upwardly with compressed air supplied from the air pump 18, the inflation forces the projection for sole 40 upwardly, thereby applying pressing massage to the back U of the front portion of the foot F.

Moreover, as the rear third air bag 41a is inflated upwardly with compressed air supplied from the air pump 18, the inflation forces the projection for sole 40 upwardly, thereby applying pressing massage to the back U of the rear portion of the foot F.

That is, on actuation of the third air bags 41a (i.e., the pressing force-enhancing mechanism), the projections for sole 39 and 40 come close to and make contact with the back side U of the foot F, and their projection elements are firmly pressed against the sole U. This allows the projections for sole 39 and 40 to press themselves with greater force against the front portion and the rear portion, respectively, of the sole U, thereby applying acupressure-like pressing massage to the sole U.

As shown in the drawings such as FIGS. 2 and 3, the kneading drive mechanism 38 comprises: the drive motor 33 that produces a driving force; and a gear case 42 that effects speed reduction to a predetermined level. The drive motor 33, being built as a reversible drive source capable of rotation in both normal and reverse directions, is shared between the kneading drive mechanism 38 and the up-and-down movement mechanism 6. That is, in this embodiment, one drive motor 33 drives both the horizontal massage mechanism 5 and the up-and-down movement mechanism 6.

The gear case 42 is situated forward of the drive motor 33. In the gear case 42, a plurality of gears are housed to effect speed reduction to a predetermined level. The drive motor 33 and the gear case 42 are coupled to each other via a transmission shaft 43.

The gear case 42 rotatably supports a rotational drive shaft 44 passed therethrough. The rotational drive shaft 44 is disposed toward the bottom of the case body 2, with its axis directed in the right-left direction. The rotational drive shaft 44, constructed of an elongated shaft member, passes through the horizontal massaging members 36 and 37 in the right-left direction. The driving force from the drive motor 33 is, following deceleration to a predetermined speed by the gear case 42, transmitted to the rotational drive shaft 44.

In addition, the sole-massaging rollers 42 are mounted in impaled fashion to the rotational drive shaft 44. Each sole-massaging roller 45 is located between the horizontal massaging members 36 and 37. The sole-massaging roller 45 supports the plantar arch T of the corresponding foot F in surface-to-surface contacting relation.

The sole-massaging roller 45 has an outer periphery which is concentric or slightly eccentric with respect to the rotational drive shaft 44. The sole-massaging roller 45 is provided at the outer periphery thereof with a plurality of projection elements. The sole-massaging roller 45 rotates together with the rotational drive shaft 44, and hence rotates in synchronism with the rocking motion of the horizontal massaging members 36 and 37.

The horizontal massaging members 36 and 37 are arranged facing each other, and spaced away in the right-left direction from each other at a sufficient distance to receive the foot F of one leg in between.

The inner horizontal massaging member 36, constructed of a platelike member elongated in the front-rear direction, is shaped in conformance with the medial side of the foot F. The outer horizontal massaging member 37, constructed of a platelike member elongated in the front-rear direction, is shaped in conformance with the lateral side of the foot F. That is, a pair of the horizontal massaging members 36 and 37 are adapted to each foot F.

Each of the horizontal massaging members 36, 37 may be made of an elastic material, such as a soft or hard resin or rubber material. Preferably, the inner (proximal) surface of each horizontal massaging member 36, 37 is provided with a cushion material or a cover material, for example, to ease a feeling of contact of the foot F with the horizontal massaging member 36, 37.

The pair of horizontal massaging members 36 and 37 are each provided at the base end thereof, or specifically a front-rear intermediate portion thereof, with a converter 46. The converter 46 converts a rotational driving force from the rotational drive shaft 44 passed through the base end of the corresponding horizontal massaging member 36 or 37 into rocking motion, and transmits the motion to the corresponding horizontal massaging member 36 or 37 for kneading massage operation.

The converter 46 comprises: a rotating boss part 47 mounted on the rotational drive shaft 44 for unitary rotation with the rotational drive shaft 44; an annular fitting part 48 disposed at the base end of each of the horizontal massaging members 36 and 37 so as to fit on the outer peripheral portion of the rotating boss part 47; and a restraint part 49 that restrains the annular fitting part 48 from rotating together with the rotating boss part 47.

The rotating boss part 47, constructed of a disk-shaped member, is arranged inclined with respect to the rotational drive shaft 44. The rotating boss part 47 is fitted at the outer periphery thereof with a bearing. The rotating boss part 47 corresponding to the horizontal massaging member 36 and the rotating boss part 47 corresponding to the horizontal massaging member 37 are inclined in opposite directions so as to serve as cam surfaces. More specifically, they are inclined in a substantially V-like or inverted V-like shape during their rocking motion. The rotating boss part 47 may be formed either as an inclined rotating boss or as an eccentric rotating boss. In another alternative, the rotating boss part 47 may be formed as an inclined and eccentric rotating boss.

The annular fitting part 48 is disposed at the base end (i.e., the intermediate portion in the front-rear direction corresponding to the plantar arch T) of each of the horizontal massaging members 36 and 37. The annular fitting part 48 fits, via the bearing, to the outer peripheral portion of the rotating boss part 47 for free relative rotation.

The restraint part 49 comprises: an engaging pin protruding downwardly from the annular fitting part 48; and a restraint groove in which the engaging pin is fitted. The restraint groove is disposed toward the bottom of the case body 2, and receives therein the engaging pin for sliding motion in the right-left direction. While the restraint part 49 restrains the annular fitting part 48 against co-rotation with the rotating boss part 47, the horizontal massaging members 36 and 37 are rocked both in the front-rear direction and in the right-left direction within a predetermined range of rocking motion.

With their respective rotating boss parts 47 inclined in opposite directions, the horizontal massaging members 36 and 37 rock in substantially V-like or inverted V-like fashion as viewed from the front. That is, in response to the rotation of the rotational drive shaft 44, the respective front sides of the horizontal massaging members 36 and 37 move away from each other, and the respective rear sides of the horizontal massaging members 36 and 37 move toward each other correspondingly. Subsequently, the front sides of the horizontal massaging members 36 and 37 move toward each other, and the rear sides of the horizontal massaging members 36 and 37 move away from each other correspondingly. The horizontal massaging members 36 and 37 repeat this cycle of operation.

When causing the vertical massage mechanism 4 to roll upward (i.e., travel upward) by operating the up-and-down movement mechanism 6 while inflating the first air bags 11a for pushing the respective first rollers 13 and the second air bag 12a for pushing the second rollers 19, the foot or feet F may be pulled upward and eventually slip out of the lower insertion recess or recesses 3b (i.e., out of the main body of the lower leg massager 1).

In this regard, it has been found desirable to add a foot retention mechanism 50 to prevent slipping-off of the foot or feet F. Separately and distinctly from the first air bags 11a and the second air bag 12a, the foot retention mechanism 50 securely holds the foot or feet F during the vertical movement of the vertical massage mechanism 4.

That is, the horizontal massage mechanism 5 in this embodiment includes the foot retention mechanism 50 that prevents the foot or feet F from slipping off upwardly during the upward movement of the vertical massage mechanism 4. The foot retention mechanism 50 comprises at least one fourth air bag 50a which is inflated and deflated repeatedly. The at least one fourth air bag 50a, or specifically the at least one foot-holding air bag 50a, is preferably placed in a position for holding down the corresponding ankle K and nearby areas (refer to FIG. 2).

In the inflated state, the at least one fourth air bag 50a holds down the corresponding foot F. This prevents the foot F from slipping off upwardly during the time when the vertical massage mechanism 4 is being moved upward by drive operation of the up-and-down movement mechanism 6.

More specifically, in distinction from the first air bags 11a for pushing the first rollers 13 and the second air bag 12a for pushing the second rollers 19, the at least one fourth air bag 50a preferably has air supply and exhaust arrangement, for example, compressed-air supply switching arrangement.

In another alternative, separately from the drive motor 33 for driving the up-and-down movement mechanism 6 that enables vertical rolling movement (i.e., vertical travel) and the horizontal massage mechanism 5 for kneading the foot or feet F, there is provided arrangement such that, with the horizontal massage mechanism 5 for kneading the foot or feet F set in a closed position where the upper portion/portions thereof is/are proximate to the foot or feet F to hold the foot or feet F underneath, the up-and-down movement mechanism 6 can be operated in isolation in a manner permitting vertical rolling movement (i.e., vertical travel). Such arrangement may be installed in a controller 51 which will hereafter be described.

The lower leg massager 1 further includes the controller 51 configured to control the vertical massage mechanism 4 and the horizontal massage mechanism 5.

The controller 51 is configured to control the supply of compressed air to the third air bags 41a and the supply of compressed air to the first and second air bags 11a and 12a in a switchable manner.

For example, when the second air bag 12a for pushing the second rollers 19 is inflated first, the calf or calves C and the shin or shins S may wrongly be frontwardly forced out of the upper insertion recess or recesses 3a. With this in view, the controller 51 is configured to exercise control in a manner such that the second air bag 12a for pushing the second rollers 19 is inflated following the completion of inflation of the first air bags 11a for pushing the first rollers 13.

In addition, the controller 51 is configured to exercise control in a manner permitting adjustment of the abutting contact position of the rear treatment members 8, each comprising the second roller 19, in the front-rear direction (i.e., the position where the second roller 19 makes contact with the back side of the calf C in the front-rear direction) by inflating the second air bag 12a for pushing the second rollers 19 prior to inflating the first air bags 11a for pushing the first rollers 13.

The lower leg massager 1 further includes a pressure detector (not shown) to detect the pressure of each of the first air bag or bags 11a, the second air bag 12a, the third air bag or bags 41a, and the fourth air bag or bags 50a.

The controller 51 recognizes the pressure of each of the first to fourth air bags 11a to 50a detected by the pressure detector, or specifically a pressure sensor. For example, in accordance with the points that are to be controlled, including pressing-strength settings and pressure adjustment for safety, the controller 51 adjusts the pressure of each of the first to fourth air bags 11a to 50a.

The lower leg massager 1 embodying the present invention may preferably have the following structural features.

The lower leg massager 1 may be configured so that the first air bags 11a for pushing the first rollers 13 and the second air bag 12a for pushing the second rollers 19 are driven by one common air pump 18 and one common electromagnetic valve, or that the first air bags 11a are driven by one air pump or the like and the second air bag 12a is driven by another air pump or the like.

The lower leg massager 1 may preferably be configured so that the third air bags 41a for pushing the projections for sole 39 and 40 are driven independently of the first air bags 11a and the second air bag 12a, that is; the three groups of air bags 11a, 12a, and 41a are inhibited from operatively connecting to one another when driven.

For example, the air pump is provided for each of the three groups of air bags 11a, 12a, and 41a on an individual basis, or alternatively a holding electromagnetic valve is mounted to an air hose connecting the three groups of air bags 11a, 12a, and 41a together. It is naturally satisfactory to adopt arrangement such that these air bags are driven by one common air pump and one common electromagnetic valve as long as the controller 51 is capable of exercising control in the above-described manner.

As grounds for above, when inflating the third air bags 41a provided for the projections for sole 39 and 40 while keeping the first air bags 11a for pushing the first rollers 13 and the second air bag 12a for pushing the second rollers 19 inflated, then the air in the first air bags 11a and the air in the second air bag 12a may momentarily flow into the third air bags 41a for pushing the projections for sole 39 and 40, thus causing momentary reduction in the squeezing force applied to the shin S and the calf C. This results in failure of the lower leg massager 1 to perform effective massage.

The lower leg massager 1 may also be designed to enable massage operation for applying acupressure-like kneading massage to the shin S, the calf C, etc. by allowing the controller 51 to effect control of the air pump 18 in a manner so as to supply compressed air to the first air bag 11a for pushing the first roller 13 and the second air bag 12a for pushing the second roller 19, and also to exhaust the air from these air bags.

The lower leg massager 1 may also be designed to enable adjustment of the strength of pressing force from the first roller 13 and the strength of pressing force from the second roller 19 by controlling the amount of air intake by the first air bag 11a and the amount of air intake by the second air bag 12a, respectively, during the vertical rolling movement (i.e., vertical travel) of the vertical massage mechanism 4 effected by driving the up-and-down movement mechanism 6.

The lower leg massager 1 may also be designed to allow the vertical massage mechanism 4 to undergo vertical rolling movement (i.e., vertical travel), with the first air bag 11a and the second air bag 12a maintained in the inflated state, or to allow the vertical massage mechanism 4 to undergo vertical rolling movement during kneading massage operation on the shin S, the calf C, etc.

### [Operation Modes]

The following describes the modes of operating the lower leg massager 1 embodying the present invention with reference to the drawings.

When the power switch or operation switch of the lower leg massager 1 is in the OFF position, in the vertical massage mechanism 4, each outer treatment member 7 stays away from the corresponding rear treatment member 8. The user inserts each shin S and each calf C through the upper treatment recess 3a into the space surrounded by the corresponding outer treatment member 7, the corresponding rear treatment member 8, and the corresponding inner treatment member 9.

Also, at this time, in the horizontal massage mechanism 5, each pair of horizontal massaging members 36 and 37 are in the state where the horizontal massaging members 36 and 37 stay away from each other. The user inserts each foot F through the lower treatment recess 3b into between the horizontal massaging members 36 and 37.

After flipping the power switch to the ON position, the user selects a desired mode of massage operation with the operation switch, and, the vertical massage mechanism 4, the horizontal massage mechanism 5, the up-and-down movement mechanism 6, and the pressing mechanism 10 are thereupon set into motion.

In the vertical massage mechanism 4, compressed air is supplied to the first air bag or bags 11a of the first pressing mechanism 11 by the air pump 18, and the first air bag or bags 11a is or are thereupon inflated. In addition, compressed air is supplied to the second air bag 12a of the second pressing mechanism 12 by the air pump 18, and the second air bag 12a is thereupon inflated.

On inflation of the first air bag 11a, the corresponding outer treatment member 7 moves inward, and hence the first roller 13 comes close to the second roller 19 of the corresponding rear treatment member 8. In addition, on inflation of the second air bag 12a, the corresponding rear treatment member 8 moves inward, and hence the second roller 19 comes close to the first roller 13.

Each first roller 13 presses itself with greater force against the lateral side of the corresponding shin S, such as the tibialis anterior muscle and the peroneus longus muscle, to perform acupressure-like massage. Each second roller 19 presses itself with greater force against the back side of the corresponding calf C, such as the gastrocnemius muscle and the soleus muscle, to perform acupressure-like massage. At this time, each third roller 26 of the inner treatment member 9 presses itself against the medial side of the calf C, while supporting that side, to perform acupressure-like massage.

Each of the first air bags 11a and the second air bag 12a may be inflated and deflated repeatedly by operating the air pump 18, or may be maintained in the inflated state. It may be satisfactory if inflation or deflation of the first air bags 11a and inflation or deflation of the second air bag 12a are alternately performed.

The vertical massage mechanism 4 is moved in the vertical direction by the up-and-down movement mechanism 6. This arrangement allows the first rollers 13 of the outer treatment members 7, the second rollers 19 of the rear treatment members 8, and the third rollers 26 of the inner treatment members 9 to unitarily move up and down. Thus, with inflation and deflation of each first airbag 11a, the first roller 13 repeatedly applies acupressure-like effective pressing massage to the lateral side of the corresponding shin S with greater force. Moreover, with inflation and deflation of the second air bag 12a, each second roller 19 repeatedly applies acupressure-like effective pressing massage to the back side of the corresponding calf C with greater force. In addition, the at third roller 26 repeatedly applies acupressure-like effective massage to the medial side of the corresponding calf C.

In the horizontal massage mechanism 5, the kneading drive mechanism 38 causes each pair of horizontal massaging members 36 and 37 to rock both in the right-left direction and in the front-rear direction, thereby applying kneading massage to the corresponding foot F. In addition, the rotational drive shaft 44 rotates with accompanying rotation of each of the sole-massaging rollers 45, thereby applying pressing massage to the plantar arch T on the corresponding sole U.

Furthermore, in the horizontal massage mechanism 5, compressed air is supplied to the third air bags 41a of the third pressing mechanisms 41 by the air pump 18, and the third air bags 41a are thereupon inflated. On inflation of the third air bags 41a, the projection for sole 39 is firmly pressed against the front portion of the corresponding sole U, thereby applying effective pressing massage to the front portion of the sole U with greater force, and also the projection for sole 40 is firmly pressed against the rear portion of the sole U, thereby applying effective pressing massage to the rear portion of the sole U with greater force. Thus, each pair of projections for sole 39 and 40 apply acupressure-like pressing massage to the corresponding sole U.

At this time, the fourth air bag or bags 50a of the foot retention mechanism 50 is inflated to prevent the corresponding foot F from slipping upwardly out of the corresponding lower treatment recess 3b.

Inflating the third air bag 41a provided for the projection for sole 39 situated forward of the sole-massaging roller 45 causes the front portion of the foot to rise. This reduces pressing stimulation that the sole receives from the sole-massaging roller 45. Similarly, inflating the third air bag 41a provided for the projection for sole 40 situated rearward of the sole-massaging roller 45 causes the rear portion of the foot to rise. This reduces pressing stimulation that the sole U receives from the sole-massaging roller 45. Concurrent lifting of the projection for sole 39 and the projection for sole 40 reduces pressing stimulation that the entire sole U receives from the sole-massaging roller 45. That is, the strength of stimulation force applied to the sole U by the sole-massaging roller 45 can be adjusted by adjustment of the degree of inflation of the third air bags 41a provided for each pair of projections for sole 39 and 40.

The lower leg massager 1 embodying the present invention includes the pressing mechanism 10, namely the first air bag 11a (i.e., the first pressing mechanism 11) and the second airbag 12a (i.e., the second pressing mechanism 12), that enables movement of the outer treatment member 7 and the rear treatment member 8, each configured to perform massage, when applying massage to a treatment target area of the lower leg, such as the calf C and the shin S. This arrangement allows the first roller 13 (i.e., the outer treatment element 13) provided in the outer treatment member 7 and the second roller 19 (i.e., the rear treatment element 19) provided in the rear treatment member 8 to be firmly pressed against the treatment target area such as the calf C and the shin S, thereby performing massage on the treatment target area with greater massage effect.

The lower leg massager further includes the third air bag 41a (i.e., the third pressing mechanism 41) disposed below the projection for sole 39, 40. On inflation of the third air bag 41a, the projection for sole 39, 40 is firmly pressed against the sole U, thereby performing more effective massage.

The lower leg massager further includes the fourth air bag 50a (i.e., the foot retention mechanism 50) positioned so as to lie above the ankle K. In the inflated state, the fourth air bag 50a prevents the foot F from slipping upwardly out of the case body 2.

It should be understood that the embodiments as disclosed herein are considered in all respects as illustrative only and not restrictive. In particular, for such matters as not explicitly specified in the disclosure of the embodiments, for example, working conditions, operating conditions, and the dimensions, weights, etc. of the constituent components, those that do not depart from the practical range to be normally complied with by persons skilled in the art and that conform to matters of common knowledge among the skilled persons are adopted herein.

For example, the shape and length of the arm member 14 and the limit of the horizontal movement of the arm member 14 in the outer treatment member 7, and the dimensions, the degree of inflation (i.e., the level of pressing pressure), etc. of the first air bag 11a in the first pressing mechanism 11 may be suitably changed in accordance with the range of areas to be massaged.

Moreover, the limit of the frontward movement of the second roller 19 in the rear treatment member 8, and the dimensions, the degree of inflation (i.e., the level of pressing pressure), etc. of the second air bag 12a in the second pressing mechanism 12 may be suitably changed in accordance with the range of areas to be massaged.

Furthermore, for the third pressing mechanism 41, the dimensions, the degree of inflation (i.e., the level of pressing pressure), etc. of the third air bag 41a may be suitably changed in accordance with the range of areas to be massaged.

In addition, for the foot retention mechanism 50, while the fourth air bag 50a may be positioned so as to lie above the ankle K, the location of the fourth air bag 50a may be suitably determined in accordance with the range of areas to be massaged. It is only required that the fourth air bag 50a is placed in a position for preventing the foot F from slipping upwardly out of the case body 2.

Although not shown in the description of the embodiments, the pressing mechanism 10 may include a mechanism that enables pressing massage to the medial side of the calf C by varying the position of the inner treatment member 9. For example, an air bag (i.e., pressing mechanism 10) is disposed toward the inner treatment member 9. Thus, the inner treatment member 9 (i.e., the third roller 26) is configured to apply pressing massage to the medial side of the calf C while being moved toward the outer treatment member 7 with inflation of the air bag.

In the lower leg massager 1, the length of the horizontal massaging member 36, 37, the angle of inclination of the horizontal massaging member 36, 37 with respect to the rotational drive shaft 44, the spaced interval between the horizontal massaging members 36 and 37 in the right-left direction, etc. may be suitably changed in accordance with the range of areas to be massaged.

Besides, the lower leg massager 1 embodying the present invention may be set in a freely-selected position for use. For example, the lower leg massager 1 may be used either in a standing state or in a lying-back state.

### REFERENCE SIGNS LIST

1 Lower leg massager
2 Case body
3 Treatment recessed part
3a Upper treatment recess
3b Lower treatment recess
4 Vertical massage mechanism
5 Horizontal massage mechanism
6 Up-and-down movement mechanism
7 Outer treatment member
8 Rear treatment member
9 Inner treatment member
10 Pressing mechanism
11 First pressing mechanism
11a First air bag
12 Second pressing mechanism
12a Second air bag
13 Outer treatment element (First roller)
14 Arm member
16 Rock shaft
17 Coil spring
18 Air pump
19 Rear treatment element (Second roller)
20 Guide arm member
21 Support shaft
23 Air bag holder
24 Lift arm member (Pusher)
25 Coil spring
26 Inner treatment element (Third roller)
27 Arm member
28 Driver
29 Screw shaft
30 Slider piece
31 Vertical travel slider
32 Vertical rail
33 Drive motor
34 Gear case
35 Position detector
36 Horizontal massaging member (Inner horizontal massaging member)
37 Horizontal massaging member (Outer horizontal massaging member)
38 Kneading drive mechanism
39 Sole treatment member (Projection for sole situated toward the front)
40 Sole treatment member (Projection for sole situated toward the rear)
41 Third pressing mechanism
41a Third air bag
45 Sole-massaging roller
46 Converter
50 Foot retention mechanism
50a Fourth air bag
51 Controller
L Lower leg
C Calf
S Shin
F Foot
T Plantar arch
U Sole

1. A lower leg massager, comprising:
a vertical massage mechanism to move in a vertical direction for performing massage operation on a calf and a shin which are treatment target areas,
the vertical massage mechanism including
an outer treatment member, formed so as to cover a lateral side of the shin, for pressing the lateral side of the shin,
a rear treatment member, disposed inwardly of the outer treatment member so as to lie behind the calf, for pressing a back side of the calf, and
a pressing mechanism to enable pressing massage to the treatment target areas by varying a position of one of the outer treatment member and the rear treatment member.

2. The lower leg massager according to claim 1, wherein
the pressing mechanism includes a first pressing mechanism, and
the first pressing mechanism enables pressing of the lateral side of the shin by varying a position of the outer treatment member in a right-left direction.

3. The lower leg massager according to claim 2, wherein
the first pressing mechanism comprises a first air bag which is inflated and deflated repeatedly, and
the first air bag is inflated to move the outer treatment member inward, thereby applying pressing massage to the lateral side of the shin.

4. The lower leg massager according to claim 1, wherein
the pressing mechanism includes a second pressing mechanism, and
the second pressing mechanism enables pressing of the back side of the calf by varying a position of the rear treatment member in a front-rear direction.

5. The lower leg massager according to claim 4, wherein
the second pressing mechanism comprises a second air bag which is inflated and deflated repeatedly, and
the second air bag is inflated to move the rear treatment member frontward, thereby applying pressing massage to the back side of the calf.

6. The lower leg massager according to claim 2, wherein
a horizontal massage mechanism is provided to perform massage operation on a foot,
the horizontal massage mechanism includes a sole treatment member in projection form, mounted so as to lie under the foot, for pressing a back side of the foot,
the pressing mechanism includes a third pressing mechanism, and
the third pressing mechanism enables pressing of the back side of the foot by lifting the sole treatment member upward.

7. The lower leg massager according to claim 6, wherein
the third pressing mechanism comprises a third air bag which is inflated and deflated repeatedly, and
the third air bag is inflated to move the sole treatment member upward, thereby applying pressing massage to the back side of the foot.

8. The lower leg massager according to claim 2, wherein
the horizontal massage mechanism includes a foot retention mechanism to prevent the foot from slipping off upwardly during upward movement of the vertical massage mechanism.

9. The lower leg massager according to claim 8, wherein
the foot retention mechanism comprises a fourth air bag which is inflated and deflated repeatedly, and
the fourth air bag is inflated to hold down the foot, thereby preventing the foot from slipping off upwardly during a time when the vertical massage mechanism is being moved upward by drive operation of an up-and-down movement mechanism.

10. The lower leg massager according to claim 5, further comprising:
a controller to control the vertical massage mechanism, wherein
the controller is configured to exercise drive control so as to effect supply of compressed air to the first air bag and supply of compressed air to the second air bag in a switchable manner.

11. The lower leg massager according to claim 10, wherein
the controller is configured to exercise control in a manner such that the second air bag is inflated following completion of inflation of the first air bag.

12. The lower leg massager according to claim 10, wherein
the controller is configured to exercise control in a manner permitting adjustment of an abutting contact position of the rear treatment member in the front-rear direction by inflating the second air bag prior to inflating the first air bag.

13. The lower leg massager according to claim 10, further comprising:
a pressure detector to detect a pressure of at least one of the first air bag and the second air bag, wherein
the controller is configured to recognize the pressure of the first air bag and/or the pressure of the second air bag detected by the pressure detector, and then adjust the pressure of each of the first air bag and the second air bag.

14. The lower leg massager according to claim 3, wherein
the vertical massage mechanism includes an inner treatment member, positioned face to face with the outer treatment member, for pressing a medial side of the calf, and
the inner treatment member is configured to apply pressing massage to the medial side of the calf while being moved toward the outer treatment member by the pressing mechanism.

15. The lower leg massager according to claim 4, wherein
a horizontal massage mechanism is provided to perform massage operation on a foot,
the horizontal massage mechanism includes a sole treatment member in projection form, mounted so as to lie under the foot, for pressing a back side of the foot,
the pressing mechanism includes a third pressing mechanism, and
the third pressing mechanism enables pressing of the back side of the foot by lifting the sole treatment member upward.

16. The lower leg massager according to claim 4, wherein
the horizontal massage mechanism includes a foot retention mechanism to prevent the foot from slipping off upwardly during upward movement of the vertical massage mechanism.
